(19) United States
(12) Patent Application Publication
(10) Pub. No.: US 2017/0363254 A1
(43) Pub. Date: Dec. 21, 2017

(54) System and Method for Manifolding Portable Cryogenic Containers

(71) Applicant: Chart Inc., Ball Ground, GA (US)

(72) Inventor: Tom Drube, Lakeville, MN (US)

(73) Assignee: Chart Inc., Ball Ground, GA (US)

(21) Appl. No.: 15/533,579

(22) PCT Filed: Dec. 11, 2015
(86) PCT No.: PCT/US15/65361

§ 371 Date: Jun. 6, 2017

Related U.S. Application Data
(60) Provisional application No. 62/091,139, filed on Dec. 12, 2014.

(51) Int. Cl. F17C 13/06; F17C 3/10; F17C 13/08

(52) U.S. Cl. CPC F17C 13/06; F17C 13/083; F17C 3/10; F17C 2203/0387

(57) ABSTRACT

A cryogenic fluid delivery manifold system includes a plurality of cryogenic supply tanks. A liquid flow manifold permits flow of liquid a use device. A vapor pressure manifold is coupled to the supply tanks and to a pusher tank for regulating and/or balancing pressure across the plurality of supply tanks.

### REFERENCE TO PRIORITY DOCUMENT

This application claims priority to co-pending U.S. Patent Application Ser. No. 62/091,139 entitled “System for Manifolding Portable Cryogenic Containers”, filed on Dec. 12, 2014. Priority to the aforementioned filing date is claimed and the provisional patent application is incorporated herein by reference in its entirety.

### BACKGROUND

Interest in the use of liquid natural gas (LNG) as a fuel for motor vehicles or other devices has increased dramatically in recent years. LNG is relatively inexpensive and provides an alternative to fuel oil from foreign sources. In addition, it burns very cleanly, making it much easier for fleets to meet more restrictive pollution emission standards. A rail locomotive is one type of vehicle that utilizes LNG as a fuel. The rail locomotive hauls a tender car, or rail tender, that contains the locomotive's LNG for fuel. There are various ways to provide the LNG from the rail tender to the locomotive's engine.

### SUMMARY

Disclosed are various embodiments of a cryogenic fluid delivery manifold system that includes a plurality of cryogenic tanks and a first, liquid flow manifold that permits flow of liquid a use device, and a second, vapor pressure manifold through which vapor flows for regulating and/or balancing pressure across the plurality of tanks. The vapor pressure manifold is also fluidly coupled to a pusher tank, as described below.

In one aspect, there is disclosed a cryogenic fluid supply system, comprising: a plurality of cryogenic supply tanks, wherein each tank includes: a. a cryogenic liquid and a vapor above the liquid; b. a vapor line having a first end in fluid communication with the vapor of the tank; c. a liquid line having a first end in fluid communication with the liquid of the tank; a pusher tank that acts to supply vapor pressure to the supply tanks and that contains a cryogenic liquid and a vapor above the liquid, the pusher tank including a dedicated pressure building system formed of a pressure line that communicates on one end with the liquid of the pusher tank, and on another end with the vapor of the pusher tank, the pressure building system also including a vaporizer positioned along the pressure line to vaporize liquid from the pusher tank and direct the vaporized liquid back to the vapor in the pusher tank for pressurizing the pusher tank; a vapor manifold that fluidly couples the vapor lines of the supply tanks to one another and also fluidly couples vapor lines of the supply tanks to a pusher line that communicates with the liquid of the pusher tank, the pusher line including a vaporizer that vaporizes liquid from the pusher tank; and a liquid manifold that fluidly couples the liquid lines of the supply tanks to one another, wherein the liquid manifold communicates with a use line that is configured to be connected to a use device.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 shows a schematic representation of a manifold system where multiple containers are fluidly connected to a single fluid line that provides for fluid to a use device.

FIG. 2 shows a first embodiment of an improved manifold system.

FIG. 3 shows a second embodiment of a manifold system.

FIG. 4 shows a third embodiment of a manifold system.

### DETAILED DESCRIPTION

Before the present subject matter is further described, it is to be understood that this subject matter described herein is not limited to particular embodiments described, as such may of course vary. It is also to be understood that the terminology used herein is for the purpose of describing particular embodiments only, and is not intended to be limiting. Unless defined otherwise, all technical terms used herein have the same meaning as commonly understood by one skilled in the art to which this subject matter belongs.

One way to provide LNG from a rail tender to a locomotive's engine is to provide a pump that is submersed within LNG in a tank of the rail tender. The pump is configured to pump the LNG to the locomotive when pressure within the tank is insufficient to drive LNG to the engine based on pressure alone. When pressure in the tank is sufficient, LNG can be driven to the locomotive by tank pressure alone through the pump. Such systems include an economizer circuit that is used to relieve high pressure within the tank. The economizer circuit typically includes a regulator that allows vapor from the tank to be delivered to the locomotive when the pressure in the tank rises above a predetermined level. By pulling vapor from the tank, the pressure in tank falls dramatically and pressure within the tank is relieved.

Another type of system is a saturation delivery style system that requires the LNG to be saturated (warmed) to a boiling pressure slightly above the operational input pressure to the engine, which may be in the range of 125-135 psig for example. Once saturated, the LNG is of sufficient pressure to enable pressure transfer of the LNG to the locomotives of the rail system. Such systems can also include an economizer circuit that is used to relieve high pressure within the tank. The economizer circuit typically includes a regulator that allows vapor from the tank to be delivered to the locomotive when the pressure in the tank rises above a predetermined level. By pulling vapor from the tank, the pressure in tank falls dramatically and pressure within the tank is relieved.

Of particular interest is the use of ISO (International Standards Organization) or other type of portable containers (or tanks) for storing the LNG. One issue that arises is the total heat management of the LNG to control boil off gas. It is good value proposition to avoid the amount of handling and trans filling of the LNG to the tanks as each of these efforts add thermodynamic heat to the LNG reduces hold time and creates potential venting of the boil off gas. Using ISO containers directly for storage and delivery to a use device avoids additional handling, which is costly, increases spill potentials and adds heat.

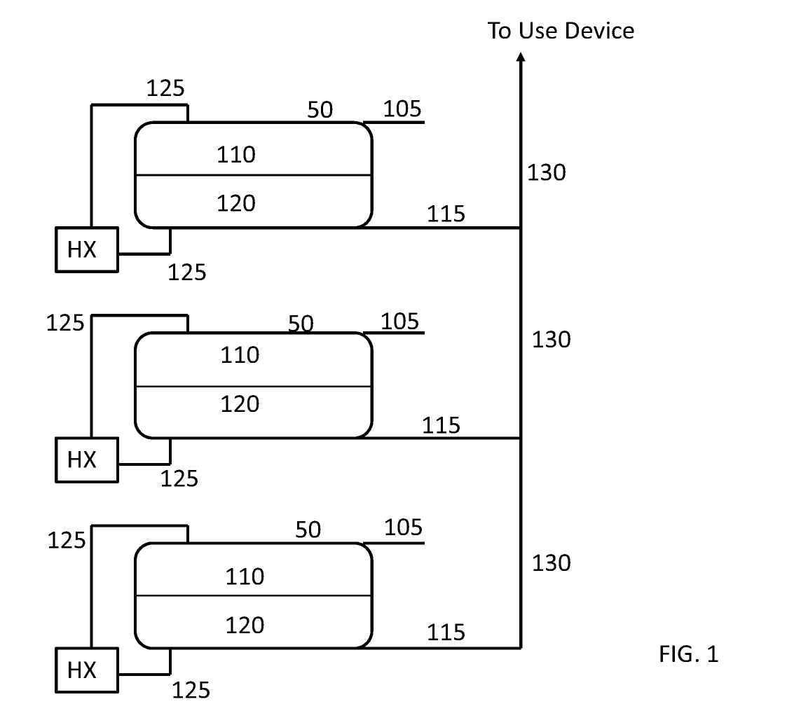

If a use device requires relatively small flow rates and small aggregate storage, the use of only a single ISO container may well represent an attractive and cost effective option. However, multiple containers may be required where flow rates, aggregate storage and requirements for uninterrupted service are present. Accordingly it is desirable to connect multiple ISO containers (or other types of containers) to a single gas use line and allow each container to supply gas to the single, common line and to the use device. This is referred to as a manifolded system such as shown in FIG. 1.

A typical ISO container configuration is horizontal in design. That is, the container is wider than it is tall. This is required so the package is easily transportable. As shown in FIG. 1, the system includes a plurality of supply tanks 50. Each tank 50 contains a cryogenic product, such as liquid natural gas (LNG), that includes liquid cryogen 120 with vapor space or vapor side 110 above the liquid cryogen within the tank.

Each container or tank 50 also has a pipe (or “line”) 105 fluidly connected to the vapor side 110 (or upper portion) of the tank 50 and a pipe (or “line”) 115 to the liquid side 120 (or lower portion) of the tank as shown in FIG. 1 where the pipes are schematically represented. The lines 115 each connect to a manifold that connects the lines 115 common use line 130 that is fluidly coupled to a use device, such as an engine. Thus, a manifold system connects the lines 115 to the use line 130. Each pipe defines an internal conduit through which fluid may flow. These pipes (or lines) are used to fill fluid and to withdraw fluid from the tank. The system may also include additional, dedicated pipes for filling the container with fluid and other lines for withdrawal of fluid from the tank. As used herein, a “line” or “pipe” can be any type of tubing or piping with an internal lumen through which fluid can flow. Any of the lines can include one or more flow regulators, pressure regulators, and/or valves.

In addition to the fill pipes/withdrawal pipes 105/115 there is often a pressure building system. This pressure building system includes a pipe 125 fluidly connected to the liquid portion 120 of the tank 50. In an embodiment, the pipe 125 extends downward from the liquid portion 120 such that gravity can cause fluid to flow into the pipe 125. The pipe 125 directs fluid flow (of liquid from the tank) to a heat exchanger HX, which is located along the pipe 125 and gassifies the liquid. Each pipe 135 may also include a pressure regulator. The pipe 125 directs the gasified liquid back to the top of the tank 50 after the liquid is gasified by the heat of the heat exchanger HX. One or more pumps can be coupled to any of the pipes of the system for propelling fluid. The system may also include automated flow control devices, such as one or more controllers coupled to one or more valves and/or pumps for causing and controlling flow of fluid to and from the system. When the pressure building system is open, liquid is allowed to flow by gravity through the pipe 125 to the heat exchanger HX where it boils to vapor and is returned to the vapor portion 110 of the tank via the pipe 125 fluidly coupled to the vapor region of the tank 50. This effectively increases the tank pressure. This is important to establish and maintain flow from the tank. It creates make-up volume to allow the customer to remove liquid from the tank and maintain use pressure.

A challenge with a typical portable (ISO) container is the relatively low height of the tank since it is horizontal. This means there is little head pressure or push in the tank to force liquid through the system. Further, the available space for the heat exchange on a portable system makes the amount of heat for boiling limited. The total withdrawal capacity of portable systems are both relative low and also slow in correcting pressure.

For a system with multiple containers on a single use line 130, where each tank supplies its own pressure building as shown in FIG. 1, certain problems exist. For example, pressure in the containers 50 rarely balance across the containers because pressure build lines dedicated to each tank will perform differently. In addition, different tanks 50 can be at different use levels (i.e., a different liquid head or different level of liquid) based on when they were attached to the manifold and how much use has occurred. Moreover, use demands on active tanks in the system fluctuate as additional tanks come on and off line. The resulting pressure imbalance allows the flow to the use device (e.g., an engine) to become erratic as flows drive into and out of tanks of differing pressures. This also creates additional system heat that can potentially lead to overall heat management issues and eventually venting.

Another performance problem is that newly attached tanks to the manifold system need to be allowed to pressurize to the use pressure before being opened to the manifold. The use of check valves on the discharge connections can assist, but pressure build imbalance will force uneven withdrawal increasing the activity level of tank connections and removal so the highest pressure tank will drain first. This may cause tank management issues as it may be desirable to have certain windows during the day when tank swapping is affected.

In addition, tanks that are effectively empty will have residual vapor at use pressure in them. The pressure at which the container is to be moved may well need to be at a lower pressure. Removal of the last pressure in the tank by venting is undesirable.

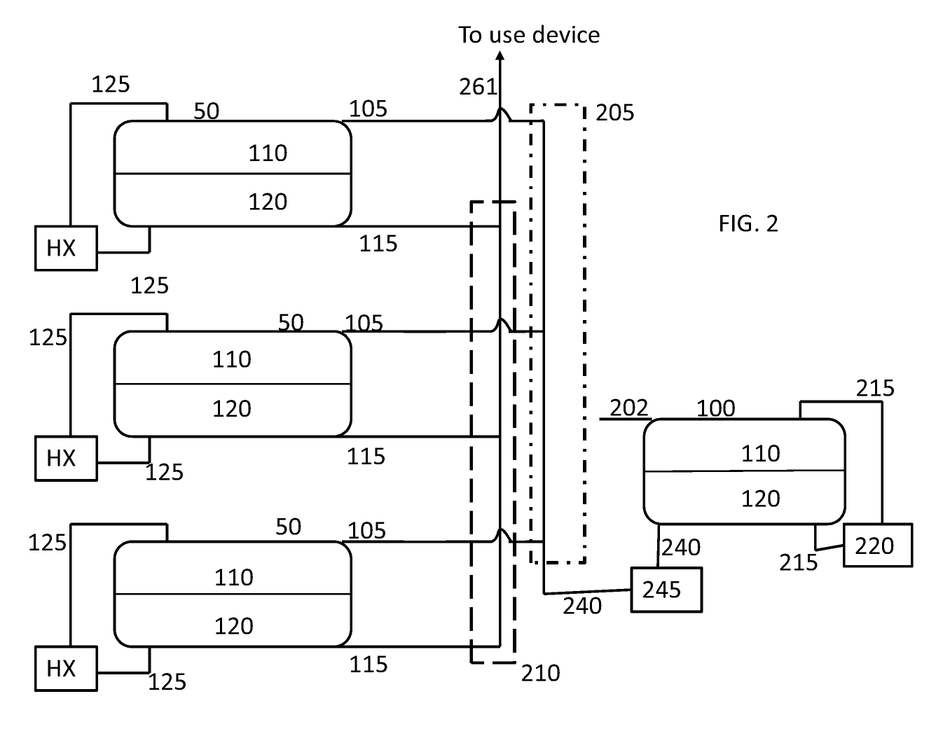

To overcome these drawbacks, disclosed are various embodiments of a cryogenic fluid delivery manifold system that includes a first manifold that permits flow of liquid, flow to the use device, a second, vapor pressure manifold through which vapor flows. FIG. 2 shows a first embodiment of a system that includes a plurality of tanks 50. The tanks 50 are arranged according to the environment of FIG. 1 and the description of the environment in FIG. 1 is also to FIG. 2. As discussed above with reference to FIG. 1, each tank 50 can include a cryogenic liquid 120 above which is located a vapor space 110. A vapor line 105 communicates with the vapor space 110 and permits vapor flow through the vapor line 105. The vapor lines 105 are fluidly connected to one another via a vapor manifold 205 that fluidly connects the vapor lines 105 to a pusher tank 100 (such as an ISO container). The vapor manifold 205 also fluidly couples the vapor lines of the supply tanks to a pusher line that communicates with the liquid of the pusher tank, the pusher line including a vaporizer that vaporizes liquid from the pusher tank, as described below. The pusher tank 100 can include a supply line 202 that communicates with the internal space of the pusher tank to fill the tank with fluid.

With reference still to FIG. 1, each tank 50 also includes a liquid line 115 that communicates with the respective liquid 120 in the tank. The liquid lines 120 are fluidly connected to one another via a liquid manifold 210. The liquid manifold 210 is fluidly connected to a use line through which fluid from the lines 105 can flow toward the use device. Thus, the liquid manifold communicates with a use line 261 that is configured to be connected to a use device

The system further includes a pressure build tank 100 dedicated on the vapor manifold 205 as a dedicated pusher tank that acts solely to supply vapor pressure to each of the tanks. Thus, the tank 100 acts as a pusher tank for providing the pressure for the system. With reference to FIG. 2, the tank 100 includes a dedicated pressure building system formed of a pressure line 215 that communicates on one end with the liquid space 120 of the tank, and on another end with the vapor space 110 of the tank 100. A pressure regulator can be positioned along the pressure line 215. A first vaporizer 220, such as a heat exchanger, is positioned along the line 215 to vaporize liquid from the liquid space 120 and directed back toward the vapor space 110 of the pusher tank for pressurizing the pusher tank 100. Thus, the line (or pipe) 215 extends downward from the liquid portion 120 such that gravity can cause fluid to flow into the pipe 215. The pipe 125 directs fluid flow (of liquid from the tank) to the heat exchanger 220, which is located along the pipe 215 and gassifies the liquid. The pipe 215 then directs the gasified liquid back to the top of the tank 100 after the liquid is gasified by the heat of the heat exchanger 220. One or more pumps can be coupled to any of the pipes of the system for propelling fluid.

Thus, the tank 100 uses its own pressure building circuit to maintain its own pressure. The tank 100 is also coupled to a pusher line 240 that includes a dedicated pusher vaporizer 245. The pusher line 240 communicates with and extends out of the liquid space 120 of the pusher tank and directs liquid from the tank 100 to the vaporizer 245. The vaporizer 245 vaporizes liquid from the pusher tank 100. The vapor discharge from the vaporizer 245 communicates to the vapor manifold 205, which also communicates with the vapor lines 105 of the tanks 50. The system permits the pressure of a newly added tank to be coupled to the manifold 205 thus quickly establishing a newly added tank to the use pressure. In this regard, the manifolds 205 and 210 can each include one or more coupling mechanisms that permit one or more additional tanks to be fluidly coupled system. In addition, the pressure in all of the ISO tanks 50 is coordinated and the withdrawal from the system can be managed by virtue of the vapor manifold 205.

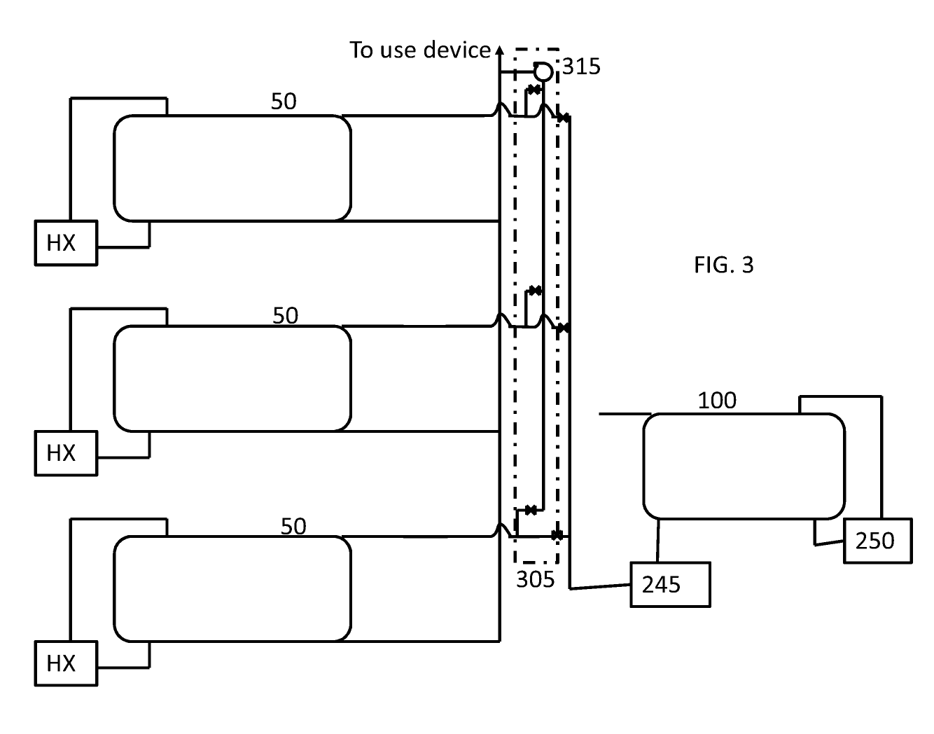

FIG. 3 shows an alternate embodiment that includes a scavenging compressor manifold 305 that is fluidly positioned in parallel fluid communication with the vapor manifold 205. This system is substantially the same as of system in FIG. 2 except that includes a compressor manifold 305 that includes a line 310 that communicates with a scavenging compressor 315. The manifold 305 is fluidly connected to a vapor manifold 205 that is configured as shown in FIG. 2. When a tank 50 is empty, the vapor from the vapor side 110 of each tank is re-directed to the scavenging compressor 305 via the vapor manifold 205 and the compressor manifold 305, which both fluidly connected to the compressor 315. The compressor can pressurize the vapor lines of the supply tanks. An empty tank can be depressurized by forcing its residual gas to the use line and avoid venting.

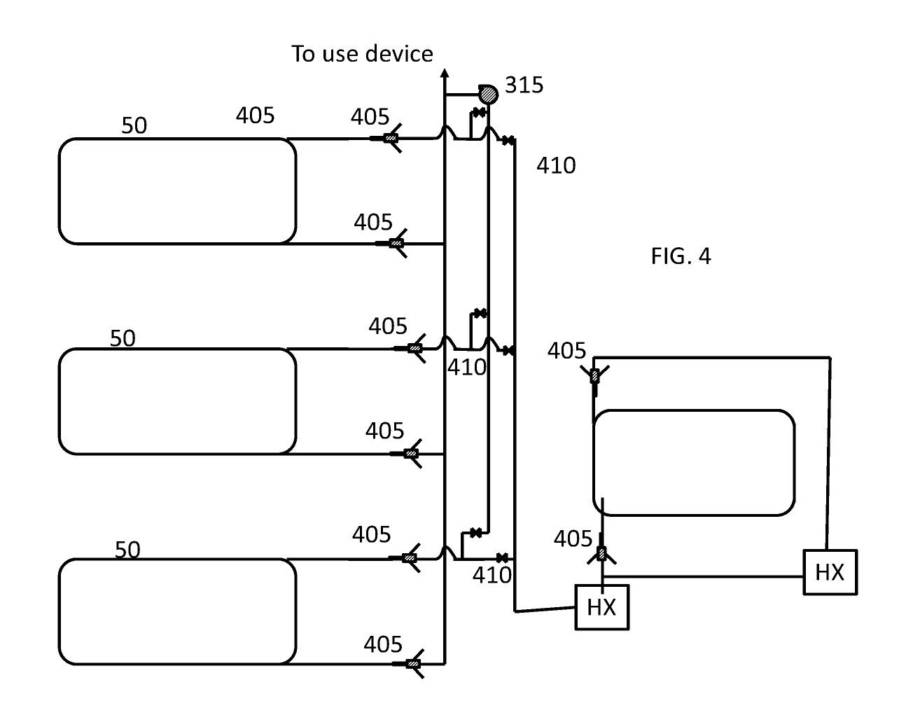

FIG. 4 shows an additional embodiment, where the tanks 50 do not include a dedicated pressure building circuit. The lack of a pressure building circuit on each tank can save weight, cost, leak potentials and complexity with respect to the previous embodiments. As shown in FIG. 4, a dry break style coupling 405 can be used on the manifold where a cheaper, lighter, receptacle side is on the ISO container and the more expensive nozzle is on the manifold. In addition, control valves 410 can be mounted to the manifold side to simplify the containers. The container level can be monitored at the manifold such as by differential pressure, load cells or other means to detect gas flow from the ISO container.

Although embodiments of various methods and devices are described herein in detail with reference to certain versions, it should be appreciated that other versions, embodiments, methods of use, and combinations thereof are also possible. Therefore, the spirit and scope of the appended claims should not be limited to the description of the embodiments contained herein.

1. A cryogenic fluid supply system, comprising:
a plurality of cryogenic supply tanks, wherein each tank includes:
a. a cryogenic liquid and a vapor above the liquid;
b. a vapor line having a first end in fluid communication with the vapor of the tank;
c. a liquid line having a first end in fluid communication with the liquid of the tank;
a pusher tank that acts to supply vapor pressure to the supply tanks and that contains a cryogenic liquid and a vapor above the liquid, the pusher tank including a dedicated pressure building system formed of a pressure line that communicates on one end with the liquid of the pusher tank, and on another end with the vapor of the pusher tank, the pressure building system also including a first vaporizer positioned along the pressure line to vaporize liquid from the pusher tank and direct the vaporized liquid back to the vapor in the pusher tank for pressurizing the pusher tank;
a vapor manifold that fluidly couples the vapor lines of the supply tanks to one another and also fluidly couples vapor lines of the supply tanks to a pusher line that communicates with the liquid of the pusher tank, the pusher line including a pusher vaporizer that vaporizes liquid from the pusher tank;
a liquid manifold that fluidly couples the liquid lines of the supply tanks to one another, wherein the liquid manifold communicates with a use line that is configured to be connected to a use device.

2. A system as in claim 1, wherein each of the supply tanks is an ISO (International Standards Organization) tank.

3. A system as in claim 1, wherein each supply chain includes a pressure building system formed of a pressure line that communicates on one end with the liquid of the supply tank, and on another end with the vapor of the supply tank, the pressure building system also including a vaporizer positioned along the pressure line to vaporize liquid from the supply tank and direct the vaporized liquid back to the vapor in the supply tank for pressurizing the supply tank.

4. A system as in claim 1, further comprising a compressor manifold that fluidly connects the vapor manifold to a compressor such that the compressor can pressurize the vapor lines of the supply tanks.

5. A system as in claim 1, wherein the first vaporizer the heat exchanger.

6. A system as in claim 1, wherein the pusher vaporizer is a heat exchanger.

7. A system as in claim 1, further comprising at least one pressure regulator on the pressure line of the pusher tank.

8. A system as in claim 1, wherein the cryogenic fluid is liquid natural gas.

9. A system as in claim 1, wherein the pressure line of the pusher tank extends downwardly from the liquid in the pusher tank.
